(19) United States
(12) Patent Application Publication
(10) Pub. No.: US 2012/0138447 A1
(43) Pub. Date: Jun. 7, 2012

(54) Solar desalination system with solar-initiated wind power pumps

(75) Inventor: Kenneth P. GLYNN, Flemington, NJ (US)

(73) Assignee: Kenergy Scientific, Inc.

(21) Appl. No.: 13/374,147

(22) Filed: Dec. 14, 2011

Related U.S. Application Data
(63) Continuation-in-part of application No. 12/387,430, filed on May 1, 2009.
Application No. 12/387,430 is a continuation-in-part of application No. 12/384,822, filed on Apr. 9, 2009, now Pat. No. 8,115,332.

(51) Int. Cl. C02F 1/14

(52) U.S. Cl. 202/189

(57) ABSTRACT

A system for creating desalinated water from seawater and also creating electricity includes a solar furnace unit. This furnace unit includes a vessel for receiving and evaporating seawater which is heated by a solar energy concentrator. Seawater can be input into the vessel and brine can be removed from the vessel. A riser pipe for steam extends upward from the vessel to a higher-elevation steam turbine generator. A drop pipe for draining desalinated water extends downward from the steam turbine generator to a hydroturbine generator. Desalinated water generates electricity as it moves through the hydroturbine generator. The desalinated water can then be subsequently used. The input for feeding seawater to the vessel includes one or more pumps that are powered from a solar-initiated wind power generating system.

### CROSS-REFERENCE TO RELATED APPLICATIONS

This application is a continuation-in-part of copending U.S. application Ser. No. 12/387,430, filed on May 1, 2009, and entitled “Solar Desalination System,” by the same inventors herein, and this application is a continuation-in-part of copending U.S. application Ser. No. 12/384,822, filed on Apr. 9, 2009, and entitled “Solar-Initiated Wind Power Generation System.”

### BACKGROUND OF INVENTION

a. Field of Invention

The invention relates generally to systems that provide for the conversion of salt water to desalinated water and for the generation of electric power. More specifically, the present invention relates to systems that utilize wind power pumps to pump saline water to a solar evaporator where solar energy is used to separate water from salt in saline water and the resulting evaporative gases are used to effectively generate electric power.

b. Description of Related Art

The following patents are representative of the field pertaining to the present invention:

U.S. Pat. No. 7,821,151 to Le et al. describes a solar power arrangement for converting solar energy into electricity comprising; a solar chimney, the chimney having a flared base spaced from the ground the chimney including a transparent surface to allow solar energy to heat air within the solar chimney. A first air turbine drives a first generator, and the chimney including an exhaust. The first air turbine drives an air compressor and wherein the compressor includes an ambient air intake and a plurality of pipes for receiving compressed attached to the solar chimney. A plurality of heliostats focus solar energy on the pipes to heat the compressed air contained therein and a second turbine driven by expansion of the compressed air wherein the second turbine drives a second generator.

U.S. Pat. No. 7,239,035 to Garces describes an integrated, wind-pumped hydro power generation system that includes at least one wind turbine generator device configured to generate output power for a common bus, and at least one hydro generator device configured to generate output power for the common bus. The hydro generator device is powered by water flow. The wind turbine generator device and the hydro generator device include corresponding local controls associated therewith, and a set of supervisory controls is in communication with the common bus and each of the local controls.

U.S. Pat. No. 6,717,285 B2 and No. 6,703,720 B1 to Ferraro both describe a wind powered generating device which comprises a tube cluster, a collector assembly, and a turbine assembly. The collector assemblies utilize sails that can be rotated to direct wind down through an inlet tube to a central outlet tube. The central outlet tube is narrowed at a portion, and a turbine is mounted at this narrowed portion to take advantage of the Venturi effect that accelerates the air as it passes the turbine. This permits reliable and efficient operation in areas that were not formerly considered windy enough to be economically feasible for the deployment of wind powered generating devices. Alternative embodiments of the inventions include mechanisms for dealing with violent weather conditions, a first of which allows excess wind to bleed off beneath and between the sails, and a second which collapses and covers the sail with a protective sheath/sock.

U.S. Pat. Nos. 6,225,705 and 6,201,313 to Nakamats both describe an energy generation system that utilizes convection flow of a fluid media caused by differences in temperature to generate useful energy therefrom. A conduit for directing convection circulation permits conversion of forces associated with the movement of the fluid media in the conduit into a usable energy by its effect of a generation device as the fluid media flows past such device.

U.S. Pat. No. 6,089,021 to Senanayake describes a power production plant and method. The power production plant includes a chimney, a conduit in the chimney, the conduit having an inlet and an outlet, and a solar energy collector having an outlet connected to the chimney characterizing by the solar collector output being connected to the inlet of the conduit, by a rotor in the said outlet, and by the conduit being offset from the central axis of the chimney. The provision of a conduit in the chimney allows the plant to be constructed in stages, and to permit power output before full completion of the plant.

U.S. Pat. No. 5,727,379 to Cohn describes an electric power generation system that combines a gas turbine generator with a solar power plant and utilizes the gas turbine exhaust for steam superheating and feed water heating only. The solar heater is only utilized for boiling or evaporation of feed water into steam, the feed water having previously been heated by a downstream portion of the turbine exhaust. In order to balance the disparity between the specific heats of water and steam to thus optimize the system, the steam is superheated by and upstream portion of the turbine exhaust to first drive a high pressure steam turbine and then reheated by the same exhaust over the same temperature range to drive a low pressure steam turbine.

U.S. Pat. No. 5,608,268 to Senanayake describes a solar chimney assembly including a chimney for receiving fluid from a solar heat collector, and a turbine driven by the fluid. The solar heat collector, which increases the moisture content and the temperature of the air flowing past the turbine, has an evaporative area and a non-evaporative area. The non-evaporative area acts as a heat absorbing area and has a first cover which inhibits evaporation of a heat-absorbing liquid retained therein. The evaporative area has a second cover connected to the chimney and arranged to contain vapor evaporating from a liquid in the evaporative area. The assembly is constructed to a transfer thermal energy from the liquid of the non-evaporative area to liquid of the evaporative area, for high efficiency operation.

U.S. Pat. No. 5,555,877 to Lockwood et al. describes a cover for withstanding stormy weather and increasingly solar heating of a body of water that is disposed over the surface of the water. The cover is more transparent to visible radiation from the sun than to infrared radiation, and is anchored and sealed around its periphery aver the surface of the body of water. Means are provided for reducing the pressure between the bottom of the cover and the top of the water to subatmospheric, and for flooding the top surface of the cover with a layer of water, and draining the layer of water from the top of the cover.

U.S. Pat. No. 5,405,503 to Simpson et al. describes a process and apparatus for desalinating seawater for brine and purifying water which contains minerals, salts, and other dissolved solids while simultaneously generating power. The salinous water is heated in a boiler to form steam and a concentrated brine. The concentrated brine is removed from the boiler, the steam produced in the boiler is washed with fresh water to remove trace salts and inorganic materials, and water bearing trace salts and inorganic materials are returned to the boiler. The washed steam is expanded across a turbine to generate electrical or mechanical power which is utilized as a product. The steam exhausted from the turbine is collected and condensed, and one portion of the condensed water is utilized as a fresh water product and another portion of the condensed water is used as the wash water to wash the steam produced in the boiler. Energy efficiency is improved by heat exchanging the hot concentrated brine against the salinous feed water or by flashing the brine to produce steam. Boiler scaling and corrosion may be controlled by feed water pretreatment. By utilizing distillation combined with power generation, demand for fresh water and power can be satisfied simultaneously.

U.S. Pat. No. 5,300,817 to Baird describes a solar venturi turbine that includes an upwardly oriented venturi tube supported by a venturi support skirt. The venturi tube includes a tapered thermopane glass enclosure which allows sunlight to project therethrough and impinge on a tapered centrifugal fan fronting the thermopane enclosure and mounted within the venturi tube. Located above the centrifugal fan in the neck of the venturi tube is a high velocity fan. A high pressure compressor is mounted above the high velocity fan, and finally a turbine is mounted above the high pressure compressor. A venturi tube outlet flares outwardly directly above the turbine and is mounted to the venturi tube. The turbine is connected to a shaft to drive an electrical generator thereby producing electricity. The sun's rays heat the air within the thermopane glass enclosure causing the reduced density air to rise within the venturi tube and propel the centrifugal fan. The air continues upwardly through the high speed fan and the high pressure compressor increasing in velocity and finally passing through and turning the turbine which is connected to the generator by the turbine shaft. Initial start-up of the solar venturi turbine is with a motor which turns both fans and the high pressure compressor. The solar venturi turbine provides a clean and environmentally harm-free source of electricity without diminishing fossil fuel reserves.

U.S. Pat. No. 4,945,693 to Cooley describes a concentic dome energy generating building enclosure it makes possible the passive transfer of renewable energy from the wind and the sun into mechanical and/or electrical energy. This invention provides the means for moving thermal and/or pneumatic pressure differentials created by the action of ambient energy on the dome through a conduit between concentric dome walls and directing these air pressure differentials through turbine at the apex of the dome building enclosure causing the turbine to rotate thereby generating power which can be used to operate tools and equipment inside the building enclosure.

U.S. Pat. No. 4,481,774 to Snook describes a canopy extends over a canyon to provide air channel with a lower entrance inlet and an upper discharge outlet. Sunlight passes through the canopy to effect heating of the air in the channel and airflow toward the upper outlet. A wind turbine may be driven by the discharging airflow.

U.S. Pat. No. 4,433,544 to Wells et al. describes a power generating station (20) having a generator (28) driven by solar heat assisted ambient wind. A first plurality of radially extending air passages (32) direct ambient wind to a radial flow wind turbine (34) disposed in a centrally located opening (46) in a substantially disc-shaped structure (21). A solar radiation collecting surface having black bodies (40) is disposed above the first plurality of air passages (32) and in communication with a second plurality of radial air passages (44). A cover plate (50) enclosing the second plurality of radial air passages (44) is transparent so as to permit solar radiation to effectively reach the black bodies (40). The second plurality of air passages (44) direct ambient wind and thermal updrafts generated by the black bodies (40) to an axial flow turbine (48) which also derives additional motive power from the air mass exhausted by the radial flow turbine (34). The rotating shaft (26) of the turbines (34) (48) drive the generator (28). The solar and wind driven power generating system operates in electrical cogeneration mode with a fuel powered prime mover (56). The system is particularly adapted to satisfy the power requirements of a relatively small community located in a geographic area having favorable climatic conditions for wind and solar powered power generation.

U.S. Pat. No. 4,331,042 to Anderson describes a solar generator that includes a chamber in the form of a half tee-pee having a chimney-like outlet at an upper end thereof. An air turbine is mounted within the outlet and is coupled to an electric generator. Air inlet tubes are provided at the base of the structure. As air within the chamber is heated by the sun, it rises and passes, at an increased velocity due to the Venturi effect, through the turbine causing the blades thereof to turn.

U.S. Pat. No. 4,323,052 to Stark describes solar energy systems that provide for the distillation of liquids and/or the production of electricity using photovoltaic cells. Apparatus are disclosed which include an undulated system for conducting the liquid to be distilled, a linear lens disposed to concentrate solar energy on or below the undulated system, and a conduit transparent to visible light interposed between the undulated system and the linear lens. A cooling fluid is supplied to the conduit for assisting condensation of liquid evaporated from the undulated system on the lower wall of the conduit. The condensed liquid, the condensate and a concentrate of the liquid being distilled are collected. An array of photovoltaic cells may be disposed in the undulated system at a location of the concentration of solar energy to thereby provide for both distillation of the liquid and generation of electricity. Instead of an undulated system for conducting the liquid to be distilled, in one embodiment, a first transparent tube is disposed in a second transparent tube. The liquid to be distilled evaporates in the first transparent tube and is condensed on the upper wall thereof which has an outer surface in contact with the cooling fluid. If desired, photovoltaic cells may also be disposed in the first transparent tube. In another disclosed embodiment, a collector comprises tubes one disposed in the other with a fluid being circulated through each tube and insulation surrounding the lower portion of the tubes. Photovoltaic cells may be disposed in the innermost tube which is transparent.

U.S. Pat. No. 4,118,636 to Christian describes, in combination, a generally conical structure for collecting air and providing a confined space for solar heating of such air, connected, at the upper end of the conical structure, with a vertically placed electric generator through which the solar-heated air passes. The combination utilizes the principle that the heated air expands and becomes lighter, causing it to be displaced by the cooler, atmospheric air at the bottom of the air collecting structure, creating an upward flow of the heated air through the electric generator. The generator is unique for the purpose in that the generator rotor and turbine turn in concert and are a single unit.

U.S. Pat. No. 4,110,172 to Spears, Jr. describes a water-containing pond for collecting solar energy for utilization in a process for recovering potable water from non-potable water and/or for the generation of power. The solar pond in designed to increase the quantity and efficiency of water evaporation, from heated pond water, into a heated flowing air stream. Construction in such that there is afforded an increase in the absorptivity/emissivity (a/e) ratio with respect to the incidence of solar radiation.

U.S. Pat. No. 3,451,220 to Buscemi describes a combined closed-cycle condensable vapor motivated turbine power plant for generating electrical power and a liquid distillation plant for desalinating sea water, wherein the brine or feed liquid heater for the distillation plant is energized by exhaust steam from a back pressure turbine. The back pressure turbine is connected in tandem with one or more condensing turbines and the back pressure turbine and condensing turbines are fed motive vapor in parallel by a common conduit, thereby providing flexibility in control of the electrical and water production rates for varying demand. The control includes an arrangement for controlling the pressure of the heating vapor admitted to the brine heater regardless of load demand on the turbines, during periods in which water distillation requirements are constant, and in which the hot exhaust vapor supply from the back pressure turbine to the brine heater may be diverted during no load requirements on the distillation plant. The invention provides a combined plant of large output capability in which the hot vapor for motivating the turbines and the brine heater may be advantageously generated by a single nuclear reactor.

U.S. Pat. No. 3,342,697 to Hammond describes a device that constitutes a multilevel plural stage evaporator for the flash distillation of saline water, economically suited for large volume purification systems. Brine heated by a primary heat source is fed to a series of multilevel trays at one end of the evaporator shell and flows through successive stages defined by compartments formed in the common chamber of the evaporator shell at progressively lower pressures to flash and produce vapor. Condenser coils on either side of the tier of trays condense the vapor which is then collected in common troughs at the base of the shell. The feed is circulated through the condenser coils countercurrent to brine flow in the trays to serve the dual purpose of condensing the vapors and preheating the feed.

U.S. Pat. No. 2,902,028 to Manly describes a solar distillation unit comprising a recessed exteriorly insulated shell, transparent means sealing said recess to form a heating zone, a removable evaporator unit positioned in said heating zone, means positioned above the heating zone for focusing the sun's rays on the surface of said evaporator unit, feed water inlet lines in fluid communication with said heating zone located adjacent each end of said evaporator unit and including means for spraying feed water over the surface of said evaporator unit, means to tiltably mount said unit to respectively raise and lower the ends thereof, valve means operable to supply feed water to the uppermost of said feed lines when the unit is tilted at an angle, means for switching said valve to supply the water to the other of said feed lines when the angle of tilt is reversed, said evaporator unit comprising a plurality of open-ended tubes lying transverse the normal flow of water, adjacent tubes being in close proximity, means for maintaining said tubes in close proximity to form a rigid removable structure, said open-ended tubes being provided with apertures to permit a limited flow of the water cascading over said tubes into the interior thereof, a vapor outlet from the heating zone and means positioned between said heating zone and said vapor outlet for preventing flow of feed water from said heating zone into said vapor outlet.

U.S. Pat. No. 2,636,129 to Agnew describes a solar engine, a reservoir, a basin for receiving liquid from the reservoir, a differential pressure conduit extending from the reservoir to the basin for passing liquid into the latter, means in said conduit for removing free air in the liquid passing therethrough, a transparent dome for the basin and comprising a plurality of flat sheets for transmitting solar rays to evaporate the liquid in the basin, an upwardly directed duct extending from said dome to conduct the evaporated liquid to a level above and at a substantially lower atmospheric pressure than that of both the reservoir and the basin, a condenser at the upper end of the duct to condense said vapors, means for removing free air from the condenser, a storage reservoir elevated above the first-mentioned reservoir, and a differential pressure conduit leading from the condenser to the storage reservoir.

United States Patent Application Publication No. 2010/0018205 A1 to Chen describes a solar power generator that includes a support, a base, a light-transmitting plate and a generator set. The base is connected to the support. The bottom of the base is provided with a plurality of air holes. The light-transmitting plate is connected to the base to form an accommodating space. The light-transmitting plate is provided with an air outlet in communication with the accommodating space. The generator set is provided in the air outlet and has an impeller and a generator connected to the impeller. When gas enters from the air holes and flows outside via the air outlet, the gas drives the impeller to rotate and then the rotation energy is converted into outputted electricity via the generator. Via this arrangement, the amount of heat exchange between internal gases and external gases and the flowing speed of gas can be increased, so that the generation performance of the generator can be improved.

United States Patent Application Publication No. 2002/0092761 A1 to Nagler describes an apparatus for the desalination or purification of water comprising a non-solid vessel having a bottom defining an opening, the vessel capable of being partially submerged below the surface of a body of water, a pan located within the vessel, the pan being flexibly connected to the inner wall of the vessel and being located beneath the surface of the water, a lens fixably connected to the top of the vessel, wherein the lens is focused beneath the surface of the water and above the surface of the pan means for varying the orientation of the vessel in accordance with the location of the sun, and means for condensing steam generated in the non-solid vessel, whereby steam generated in the non-solid vessel is condensed outside of the non-solid vessel. A method for the desalination or purification of water comprises the steps of containing a body of water within a vessel, the vessel having a lens fixably attached at the top and bottom defining an opening, located a pan just below the surface of the water, focusing the lens just beneath the surface of the water and just above he bottom surface of the pan, condensing water vapor, re-filling the vessel with water as the water is converted to steam, and periodically re-orienting the vessel in a manner that tracks movement of the sun.

Notwithstanding the prior art, the present invention is neither taught nor rendered obvious thereby.

### SUMMARY OF INVENTION

The present invention is a solar desalination system for creation of desalinated water from seawater that also produces electricity. The present invention system includes: a) a solar furnace unit, including a vessel for receiving and evaporating seawater to create desalinated steam, and a solar energy concentrator positioned adjacent the vessel to concentrate solar energy to the vessel; b) input means for feeding seawater to the vessel; c) brine output means for removal of brine water bottoms from the vessel; d) a riser pipe having a top and a bottom and being connected at its bottom and to extending upwardly from the vessel for transporting steam from the vessel the riser pipe top positioned at a predetermined vertical height from the vessel; e) an electric power-producing steam turbine generator positioned at a predetermined vertical height from the vessel, and connected to the top of the riser pipe for production of electric power with steam from the container; f) a drop pipe having a top and a bottom, and being connected at its tops to the steam turbine generator for removal of desalinated water from the steam turbine generator; g) an electric power-producing hydroturbine generator connected to the bottom of the drop pipe for production of electric power with desalinated water from the steam turbine generator; and, h) egress means for removal of desalinated water from the hydroturbine generator for subsequent use, wherein the input means for feeding seawater to the vessel includes i) at least one support member adapted to support, and being connected to and supporting, a solar canopy above ground level; ii) at least one wind-driven power turbine and generator connected to the at least one support member and to an apex of the solar canopy; iii) the solar canopy has a periphery and an inner area wherein the inner area is at least partially elevated above the periphery to establish at least one apex with a venturi effect, the solar canopy being connected to the at least one support member, the solar canopy having a major portion being selected from the group consisting of translucent material, transparent material and combinations thereof, the at least one apex of the solar canopy being functionally connected to the at least one wind-driven power turbine and generator; iv) the at least one wind-driven turbine and generator electrically connected to an electric pump, the electric pump adapted to feed seawater into the vessel.

In some preferred embodiments of the present invention solar desalination system, the riser pipe top and the steam turbine generator are at least 30 meters higher than the vessel.

In some preferred embodiments of the present invention solar desalination system, the solar energy concentrator is selected from the group consisting of a linear parabolic solar concentrator, a parabloid solar concentrator and plural mirror solar concentrator.

In some preferred embodiments of the present invention solar desalination system, the solar energy concentrator is moveably mounted, and includes solar tracking means adapted to move the solar energy concentrator to follow the sun.

In some preferred embodiments of the present invention solar desalination system, the system further includes: i) auxiliary heating means proximate the vessel and adapted to heat the vessel to assist the solar furnace. In some preferred embodiments of the present invention solar desalination system, the auxiliary heating means for the vessel is adapted to operate when solar power is insufficient to evaporate seawater in the vessel. In some preferred embodiments of the present invention solar desalination system, the auxiliary heating means this is an electric heating means that is powered from at least one of the generators.

In some preferred embodiments of the present invention solar desalination system, the riser pipe includes at least one booster heater. In some preferred embodiments of the present invention solar desalination system, the at least one booster heater is selected from the group consisting of a solar heater, a heat exchange heater, an electric heater and combinations thereof.

In some preferred embodiments of the present invention solar desalination system, the egress means includes heat exchange cooling means.

In some preferred embodiments of the present invention solar desalination system, the system further includes an elevated storage tank connected to and downstream from the steam turbine generator and connected to the drop pipe, adapted for storage and controlled release of desalinated water to provide water and power when the solar furnace unit is not producing water and electricity.

In some preferred embodiments of the present invention solar desalination system, the solar canopy is a flexible plastic canopy.

In some preferred embodiments of the present invention solar desalination system, the solar canopy is a rigid canopy selected from the group consisting of glass, glass fiber and plastic.

In some preferred embodiments of the present invention solar desalination system, the at least one wind-driven power turbine includes blades that rotate about a vertical axis.

In some preferred embodiments of the present invention solar desalination system, the at least one wind-driven power turbine includes a protective top element to inhibit rain entry.

In some preferred embodiments of the present invention solar desalination system, the at least one support member is a support column having a hollow top section wherein the hollow top section includes at least one wind entry port and contains the at least one wind-driven power turbine within the hollow top section above the at least one wind entry port, and wherein the solar canopy at least one apex is connected to the support column adjacent and above the at least one wind entry port.

In some preferred embodiments of the present invention solar desalination system, there is a plurality of apexes and there is one turbine and generator and there is a manifold connected to the plurality of apexes and connected to the one turbine and generator.

In some preferred embodiments of the present invention solar desalination system, there is a plurality of apexes and there is one turbine and generator for, and connected to, each of the plurality of apexes.

In some preferred embodiments of the present invention solar desalination system, the at least one wind-driven power turbine and generator includes blades that rotate about a non-vertical axis.

In some preferred embodiments of the present invention solar desalination system, the system further includes a heat reflecting material located a predetermined distance below the periphery of the solar canopy.

In some preferred embodiments of the present invention solar desalination system, the solar canopy has a lower portion and an upper portion and the lower portion has a greater horizontally-measured area than the upper portion.

In some preferred embodiments of the present invention solar desalination system, the solar canopy has a single apex and has a decreasing horizontally-measured area as a function of increasing height.

In yet others preferred embodiments of the present invention solar desalination system, the system includes: a) a solar furnace unit, including a vessel for receiving and evaporating seawater to create desalinated steam, and a solar energy concentrator positioned adjacent the vessel to concentrate solar energy to the vessel; b) input means for feeding seawater to the vessel; c) brine output means for removal of brine water bottoms from the vessel; d) a riser pipe having a top and a bottom and being connected at its bottom and to extending upwardly from the vessel for transporting steam from the vessel the riser pipe top positioned at a predetermined vertical height from the vessel; e) an electric power-producing steam turbine generator positioned at a predetermined vertical height from the vessel, and connected to the top of the riser pipe for production of electric power with steam from the container; f) a drop pipe having a top and a bottom, and being connected at its tops to the steam turbine generator for removal of desalinated water from the steam turbine generator; g) an electric power-producing hydroturbine generator connected to the bottom of the drop pipe for production of electric power with desalinated water from the steam turbine generator; and, h) egress means for removal of desalinated water from the hydroturbine generator for subsequent use; wherein the input means for feeding seawater to the vessel includes i) at least one support member adapted to support, and being connected to and supporting, a solar canopy above ground level; ii) at least one wind-driven power turbine and generator connected to the at least one support member and to an apex of the solar canopy; iii) the solar canopy has a periphery and an inner area wherein the inner area is at least partially elevated above the periphery to establish at least one apex with a venturi effect, the solar canopy being connected to the at least one support member, the solar canopy having a major portion being selected from the group consisting of translucent material, transparent material and combinations thereof, the at least one apex of the solar canopy being functionally connected to the at least one wind-driven power turbine and generator; iv) at least one inverter connected to the generator to convert direct current electric power from the generator to alternating current electric power; and v) the at least one wind-driven turbine and generator electrically connected to an electric pump, the electric pump adapted to feed seawater into the vessel.

In some preferred embodiments of the present invention solar desalination system as set forth in paragraph [00038], the riser pipe top and the steam turbine generator are at least 30 meters higher than the vessel.

In some preferred embodiments of the present invention solar desalination system, the solar energy concentrator is selected from the group consisting of a linear parabolic solar concentrator, a parabloid solar concentrator and plural mirror solar concentrator.

In some preferred embodiments of the present invention solar desalination system, the solar energy concentrator is moveably mounted, and includes solar tracking means adapted to move the solar energy concentrator to follow the sun.

In some preferred embodiments of the present invention solar desalination system, the system further includes: i) auxiliary heating means proximate the vessel and adapted to heat the vessel to assist the solar furnace. In some preferred embodiments of the present invention this auxiliary heating means is adapted to operate when solar power is insufficient to evaporate seawater in the vessel. In some preferred embodiments of the present this auxiliary heating means is an electric heating means that is powered from at least one of the generators.

In some preferred embodiments of the present invention solar desalination system, the riser pipe includes at least one booster heater.

In some preferred embodiments of the present invention solar desalination system, the at least one booster heater is selected from the group consisting of a solar heater, a heat exchange heater, an electric heater and combinations thereof.

In some preferred embodiments of the present invention solar desalination system, the egress means includes heat exchange cooling means.

In some preferred embodiments of the present invention solar desalination system, the system includes an elevated storage tank connected to and downstream from the steam turbine generator and connected to the drop pipe, adapted for storage and controlled release of desalinated water to provide water and power when the solar furnace unit is not producing water and electricity.

In some preferred embodiments of the present invention solar desalination system, the solar canopy is a flexible plastic canopy.

In some preferred embodiments of the present invention solar desalination system, the solar canopy is a rigid canopy selected from the group consisting of glass, glass fiber and plastic.

In some preferred embodiments of the present invention solar desalination system, the at least one wind-driven power turbine includes blades that rotate about a vertical axis.

In some preferred embodiments of the present invention solar desalination system, the at least one wind-driven power turbine includes a protective top element to inhibit rain entry.

In some preferred embodiments of the present invention solar desalination system, the at least one support member is a support column having a hollow top section wherein the hollow top section includes at least one wind entry port and contains the at least one wind-driven power turbine within the hollow top section above the at least one wind entry port, and wherein the solar canopy at least one apex is connected to the support column adjacent and above the at least one wind entry port.

In some preferred embodiments of the present invention solar desalination system, there is a plurality of apexes and there is one turbine and generator and there is a manifold connected to the plurality of apexes and connected to the one turbine and generator.

In some preferred embodiments of the present invention solar desalination system, there is a plurality of apexes and there is one turbine and generator for, and connected to, each of the plurality of apexes.

In some preferred embodiments of the present invention solar desalination system, the at least one wind-driven power turbine and generator includes blades that rotate about a non-vertical axis.

In some preferred embodiments of the present invention solar desalination system, the system further includes a heat reflecting material located a predetermined distance below the periphery of the solar canopy.

In some preferred embodiments of the present invention solar desalination system, the solar canopy has a lower portion and an upper portion and the lower portion has a greater horizontally-measured area than the upper portion.

In some preferred embodiments of the present invention solar desalination system, the solar canopy has a single apex and has a decreasing horizontally-measured area as a function of increasing height.

### BRIEF DESCRIPTION OF THE DRAWINGS

FIG. 1 is a block diagrammatic representation of some preferred embodiments of the present invention solar desalination system;

FIG. 2 shows details of one preferred embodiment of the present invention solar desalination system with three different types of electric power generation;

FIG. 3 presents a block diagram showing various preferred embodiment options for present invention power generating solar desalination systems;

FIG. 4 illustrates FIG. 1 type solar desalination systems but with elevated water storage to provide for water and power availability at night or otherwise when the solar evaporator is not operating;

FIG. 5 shows the FIG. 2 preferred present invention solar desalination system, but now including water storage with controlled release;

FIG. 6 shows the, present invention power generating solar desalination systems of FIG. 1, with steam rise pipe booster heater, optional water storage and optional heat of condensation electric power generation;

FIG. 7 shows a flow diagram for one embodiment of a continuous operation of a present invention solar desalination system; and,

FIG. 8 illustrates a flow diagram for one embodiment of a batch operation of a present invention solar desalination system;

FIG. 9 is a front view of a solar-initiated wind power generation system used to power the saltwater input pump of the present invention solar desalination system, having a canopy with two apexes, each with its own turbine and generator;

FIG. 10 is a partially cut front view of an embodiment of a solar-initiated wind power generation system used to power the saltwater input pump of the present invention solar desalination system having a canopy with a single apex and with the turbine located inside the hollow top area of the canopy support member;

FIG. 11 is a partial cut side view of an embodiment of turbine and generator and solar chimney arrangement of a solar-initiated wind power generation system used to power the saltwater input pump of the present invention solar desalination system;

FIG. 12 is a front view of an embodiment of a solar-initiated wind power generation system used to power the saltwater input pump of the present invention solar desalination system wherein the canopy is a plurality of greenhouse rigid glass roofs with two apexes that manifold into a single turbine and generator;

FIG. 13 is a front view of an embodiment of a solar-initiated wind power generation system used to power the saltwater input pump of the present invention solar desalination system wherein the canopy is a plurality of tent-like flexible clear plastic roofs with two apexes that manifold into a single turbine and generator; and,

FIGS. 14, 15, 16, 17 and 18 illustrate block diagrammatic representations of various embodiments of the solar-initiated wind power generation system used to power the saltwater input pump of the present invention solar desalination system.

### DETAILED DESCRIPTION OF THE EMBODIMENTS

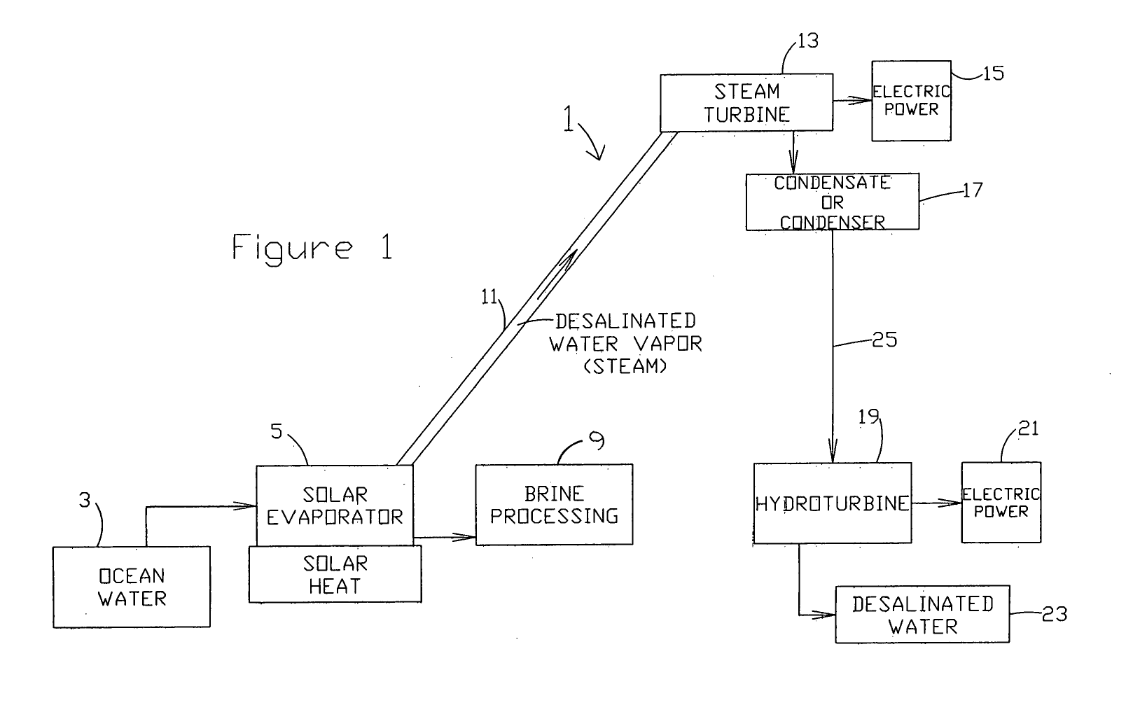

FIG. 1 is a block diagram of some preferred embodiments of a present invention solar desalination system 1. Present invention system 1 includes a supply of salt water, here ocean water 3, that is fed to or pumped (not shown) to solar evaporator 5. Solar evaporator 5 may be any solar evaporator that has been heretofore suggested or taught and thus many be a flat mirror array for reflecting vast areas of sunlight so as to be directed to a container or vessel for evaporating water out of the saline water. Alternatively, it could be a parabolic dish solar concentrator device or any other solar evaporator or furnace. The size of the solar evaporator 5 is dependent upon the ambient temperature and the volume of ocean water (capacity of the vessel) being used. Thus, solar heat 7 provides the evaporator 5 with heat energy to generate desalinated water vapor (steam that moves up riser pipe 11 a predetermined height, e.g., 200 feet), to steam turbine 13. Steam turbine 13 will be installed on a tower, building or other structure or on a natural elevated area such as a hill or cliff. Steam turbine 13 is an electric power 15 generating steam turbine and may be designed to condense the steam to water or to utilize steam and exhaust the steam.

In either case the steam turbine 13 generates electric power 15 and its H₂O effluent exits as condensate or is condensed 17 at or near the predetermined elevated steam turbine 13. Next, the water product that is dropped a predetermined height, and this height establishes a head of water that drives a water turbine. Thus, the desalinated water travels down drop pipe 25 to drive hydroturbine 19 to generate additional electric power 21. The desalinated water 23 may be treated or otherwise used as desired.

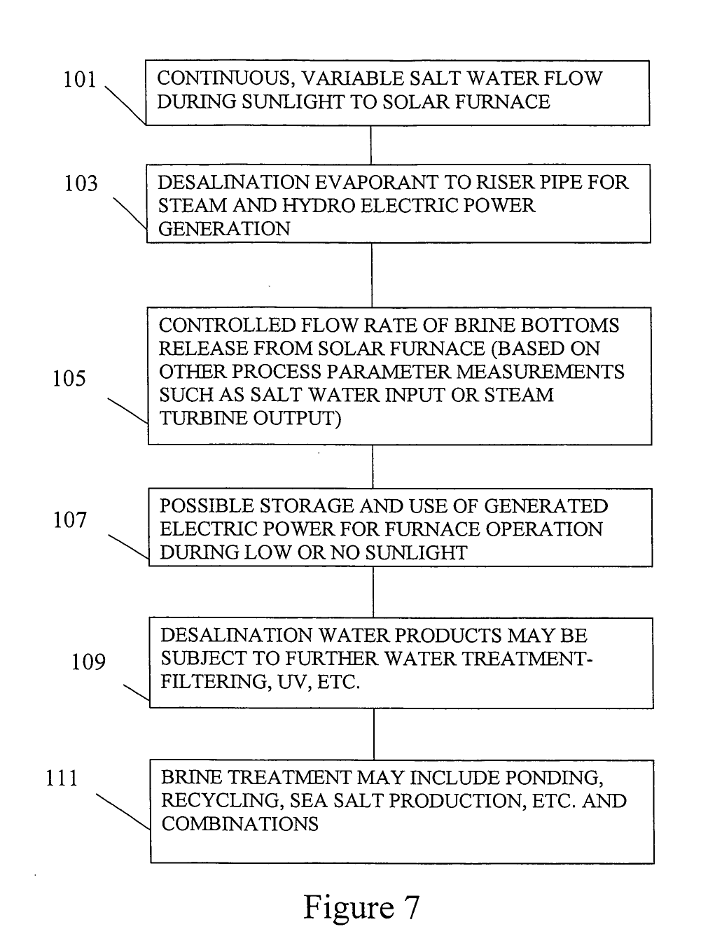

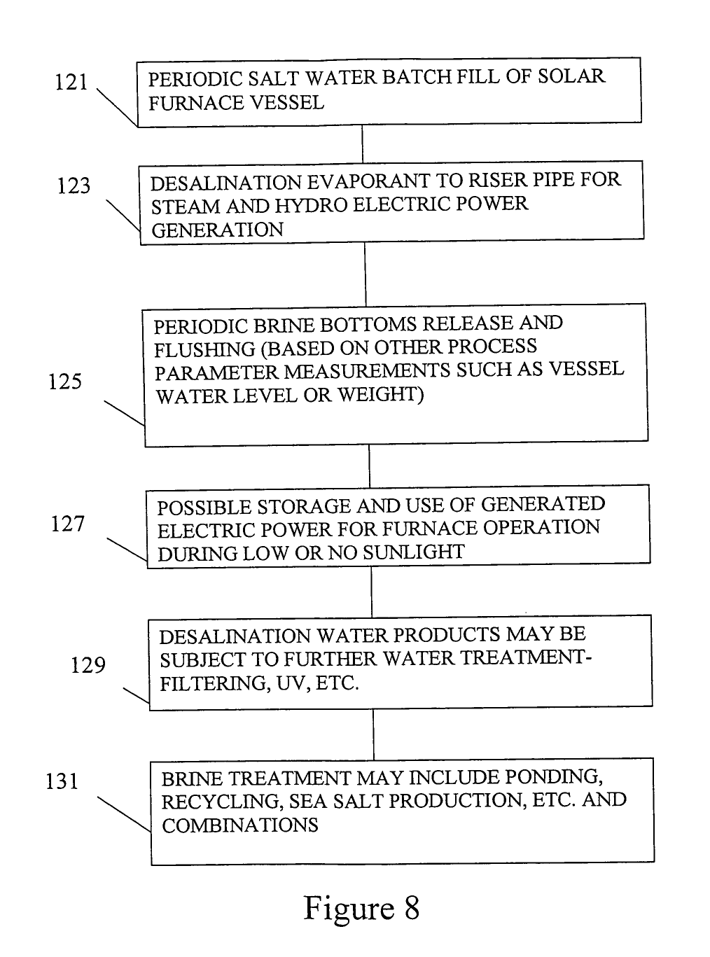

The present invention system could operate on a continuous basis much like tankless water heaters, when there is sufficient sunlight, and appropriate flow valves and controls would be necessary to assure a steady output ratio- for example, 90% tops (desalinated evaporant)/10% bottoms (brine-high density salt water). However, in many cases, the system will operate as a batch process. Details of some embodiments of continuous and batch process of the present invention are discussed below in conjunction with FIGS. 7 and 8.

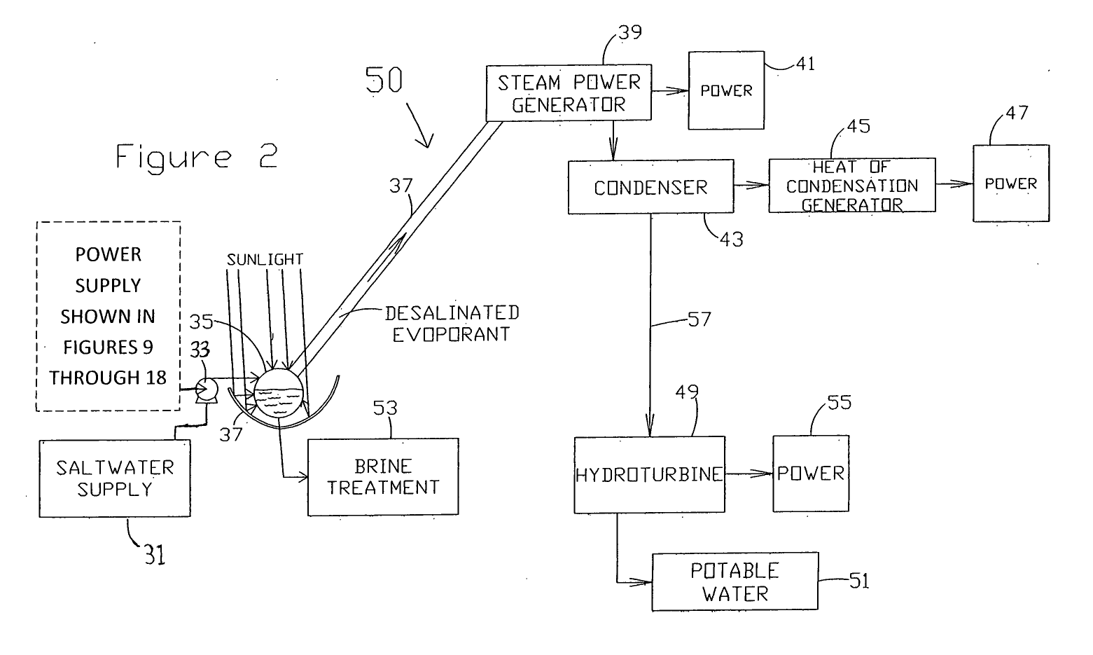

FIG. 2 illustrates a present invention solar desalination system with three different types of electric power generation. System 50 includes a salt water supply 31 and a delivery pump 33 to move the saline water to the solar furnace (evaporator). In this embodiment, the solar furnace is concentrator 37. It is positioned to concentrate solar energy (sunlight) onto vessel 35. Pump 33 is programmed to follow a sequence, such as, when the saltwater level in vessel 35 is below a certain level, a flush mode will initiate. A valve or other liquid egress control (not shown) will open vessel 35 to brine treatment 53, pump 33 may provide flushing salt water from supply 31 and, after a predetermined time or volume of flow, pump 33 will stop and the liquid egress control will close. Next, pump 33 will activate to pump a predetermined volume (or other predetermined parameter) and fill the vessel 35 to a predetermined level. The solar furnace (concentrator 37) will evaporate desalinated water until the vessel 35 is depleted to a predetermined level, and then the flushing and evaporating phases will be repeated.

When the solar concentrator 37 evaporates the desalinated water into steam (desalinated evaporant), this steam travels up riser pipe 37 to elevated steam generator 39 where the steam generates electric power 41. While still at elevation, the steam is condensed to water at condenser 43, and the heat of condensation (e.g., through heat exchangers) is committed to a heat of condensation electric power generator 45 to produce power 47.

Next, the condensed steam (desalinated water) travels down drop pipe 57 (shown as a vertical pipe, but could be a slanted pipe, as down a slope or hill), to hydroturbine 49 to generate electric power 55, and to produce useable water such as potable water 51.

This FIG. 2 present invention solar desalination system 50 creates power at three different sources-steam, heat of condensation and hydro.

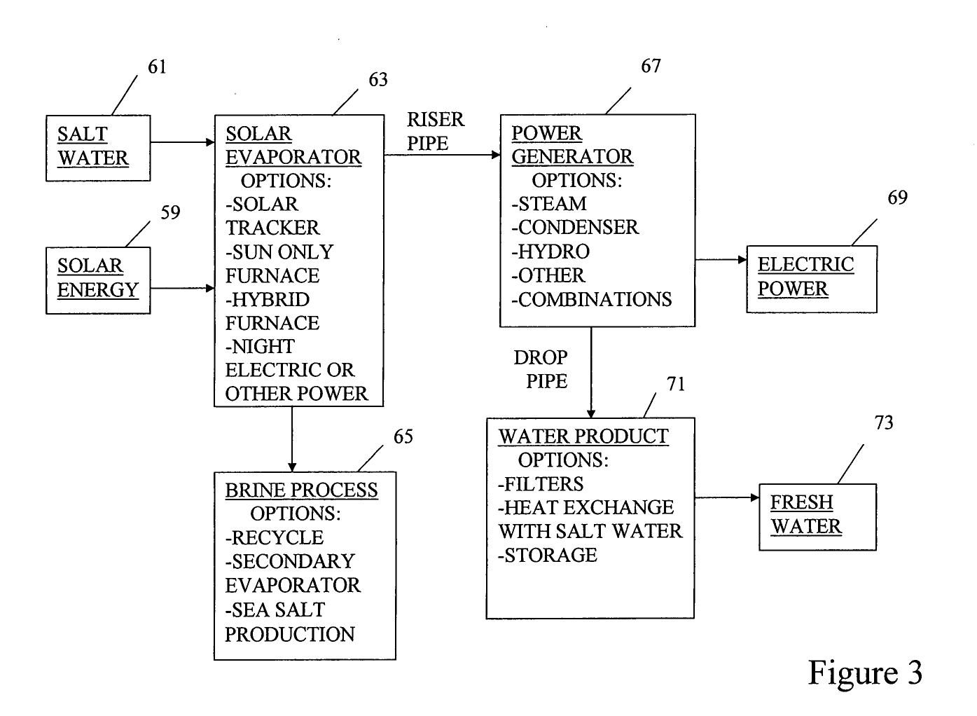

FIG. 3 illustrates a block diagram showing various options for some preferred embodiments of the present invention desalinated water-producing, electric power-generating solar desalination systems. The four larger blocks of FIG. 3 represent the four process steps of the present invention system and the four smaller blocks represent inputs and outputs. However, additional outputs are optionally viable, such as salt production and/or saline solution production. In FIG. 3, inputs include solar energy 59 and salt water 61 to solar evaporator 63. Solar evaporator 63 could be a solar furnace or a hybrid furnace. It could also have alternate energy powering for night or other use. Solar evaporator 63 preferably is rotatable and has sufficient tracking capabilities. For example, the vessel may remain stationary while the solar furnace rotates or both may rotate. Alternatively, remotely located reflectors may track the sun and solar furnace may be stationary. The brine treatment process 65 may involve a number of options including recycle, secondary evaporation and sea salt production.

The desalinated evaporant rises to a predetermined height through a column or riser pipe and the elevated water is utilized to generate electric power 69 at power generator 67. Power generator 67 options include steam, condenser, hydro, other and combinations thereof. Water product 71 illustrates various options that result in fresh water 73 and other inherent benefits.

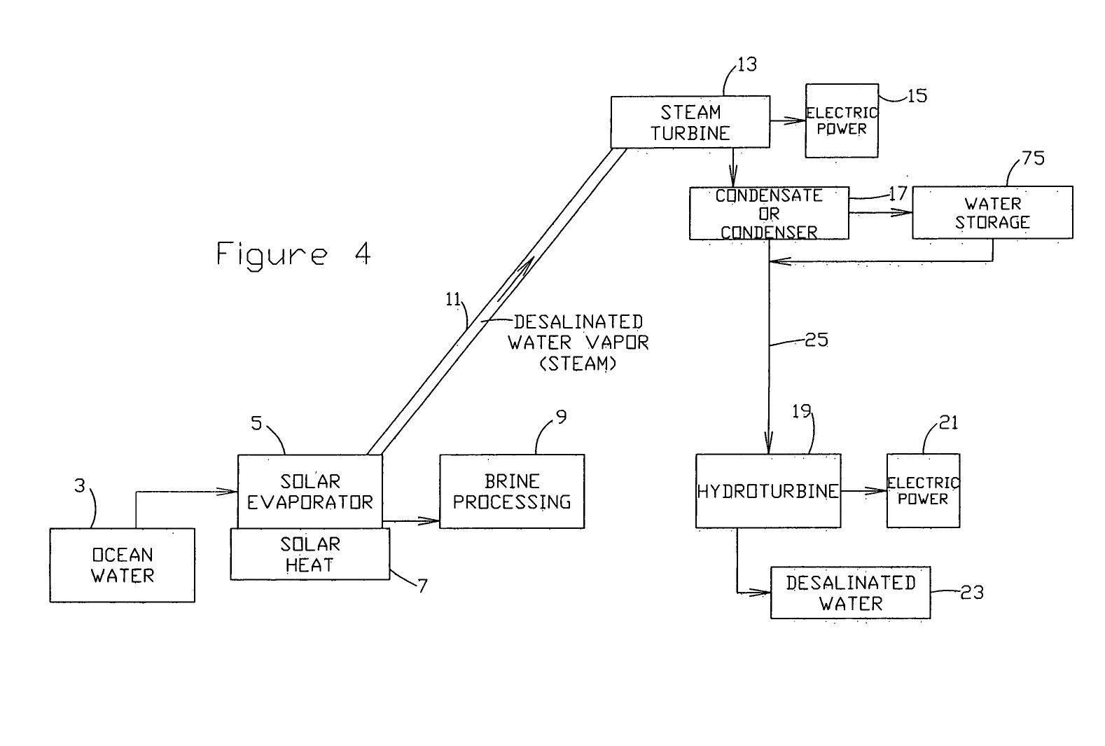

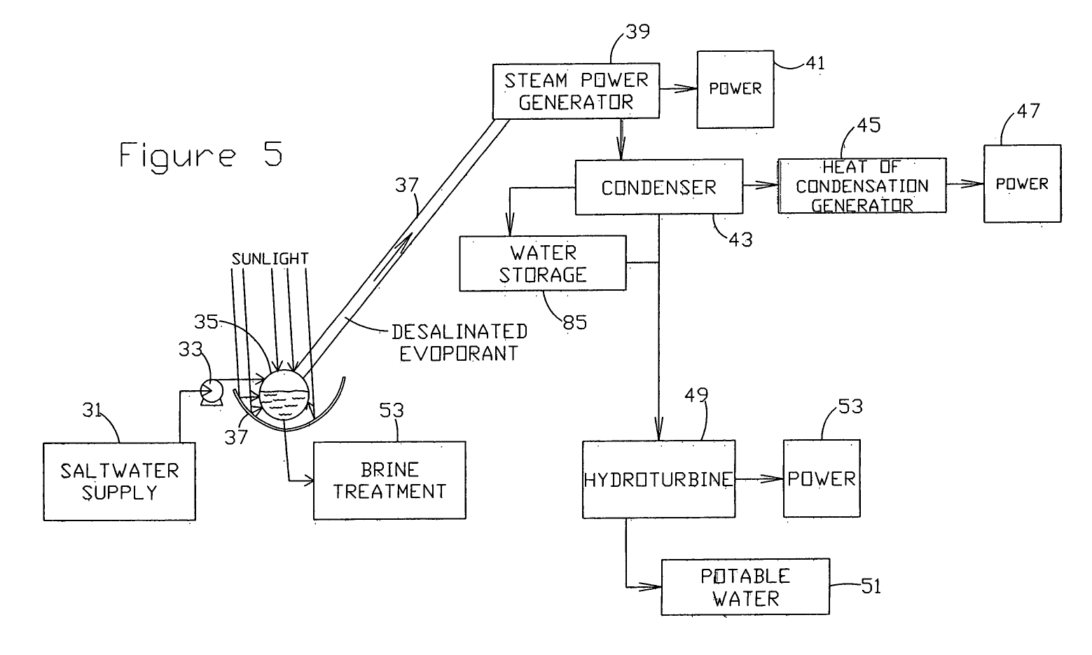

FIG. 4 is similar to FIG. 1 and identical components are identically numbered. However, in the FIG. 4 embodiments, condensate or condenser 17 water may be fed to drop pipe 25 directly or diverted to elevated water storage 75. By storing water at an elevated level, it may be released at a slow, steady continuous or nearly continuous rate to generate electricity or it may be stored and used on days with low or no sun power. Similarly, FIG. 5 shows the same present invention systems shown in FIG. 2, but includes elevated water storage 85 for the same purposes and benefits described above.

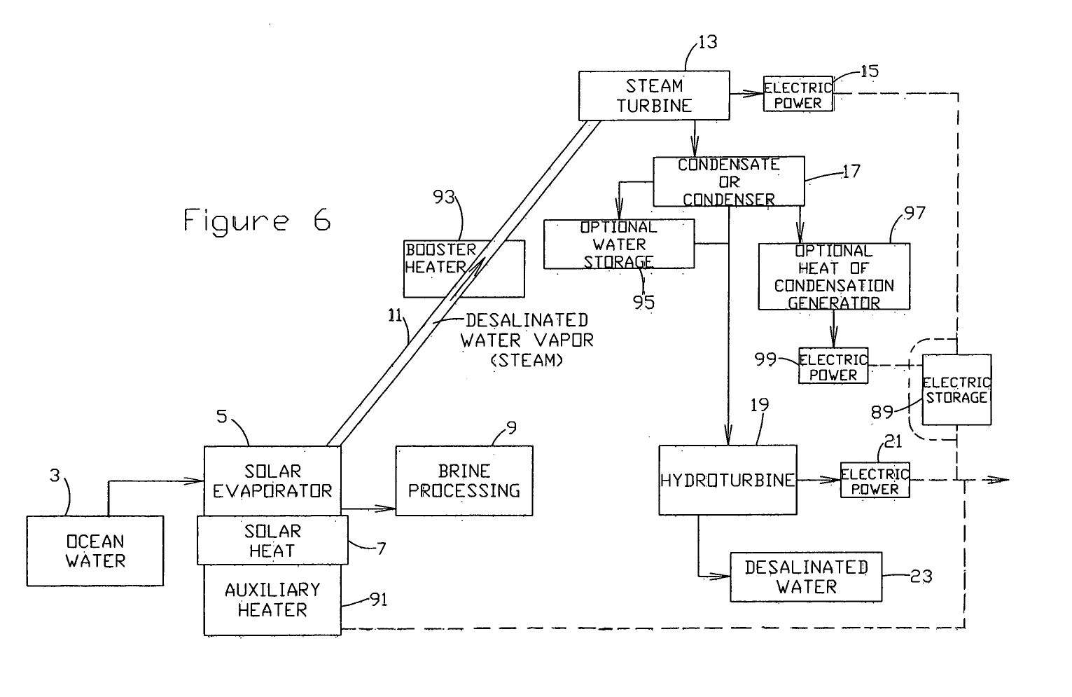

FIG. 6 illustrates variations of the FIG. 1 present invention desalinated water-producing, electric power-generating solar desalination systems, illustrating additional options. Otherwise, the elements shown in FIG. 6 that are identical to those in FIG. 1, are identically numbered. These options include a booster heater 93. The booster heater 93 could be any type of heating system, including electrical, but a solar booster would be most efficient. Also included is optional water storage 95 that may be utilized in a manner similar to water storage 75 described in conjunction with FIG. 4 above. Optional heat of condensation generator 97 produces additional electric power 99. Auxiliary heater 91 may be utilized to supplement and/or replace solar heat, depending upon sun availability, and the electric power used for auxiliary heater 91 may advantageously be taken from a grid or from the electric power generated and stored, as from electric storage 89.

FIG. 7 describes a continuous present invention solar desalination system. Block 101 illustrates that while the system is continuous, the salt water flow to the solar furnace (vessel and concentrator or collector) is variable. The quantity and rate of heat delivered to the vessel from the sun depend upon the time of day, day of year, cloudiness, wind and temperature of the incoming salt water. Thus, while the process can be continuous, the inflow of salt water must be variable to compensate for the aforesaid variables.

For example, present invention computer controlled system has a six ton volume a vessel in the form of a long tube positioned on the focal line of a linear parabolic reflector could have a top inlet for ocean water at one end and a bottom outlet for brine bottoms at the opposite end. The inlet could be fed by a variable rate pumping system (or gravity flow system where the solar furnace is located below the sea water) and the bottoms outlet could have a variable rate valving system a monitor could measure a process parameter such as vessel water level, vessel water weight or steam output and would regulate the inlet flow in accordance with defined process parameter limitations. Likewise, the bottoms outflow could be regulated by the inflow rate such as ten percent of inflow. It is desired to maintain a water level between four and five tons of salt water. The computer control program is designed to maintain the bottoms outlet valve closed during the initial fill stage. The solar furnace will begin to evaporate desalinated water to a riser pipe for steam power generation and hydro electric power generation (block 103). When the vessel water level or weight drops to, for example, five tons, the inlet pumping system will automatically pump salt water to the vessel. The computer system will recognize the inlet flow rate or steam output to open and regulate the flow rate of the brine bottoms (block 105). For example, if the water evaporates and a rate of one ton per hour then the next inlet pumping system will feed replacement salt water at the rate of one ton per hour, then and the brine bottoms outlet will permit 0.1 ton of brine to be released per hour. Such a system would generate 0.9 ton of steam per hour to generate electricity. The desalinated water could be stored at elevation and used to generate electricity though a hydroturbine at night or during low sunlight to electrically power the solar furnace for additional operational time (block 107). The desalination water products may be subject to further water treatment filtering, UV, etc. (block 109). The brine may be treated and brine treatment may include ponding recycling, sea salt production, etc. and combinations (block 111). When effective evaporation has ceased, the computer controlled system recognizes the lack of evaporant removal, and shuts down the system.

FIG. 8 illustrates the present invention process as a batch process. The salt water is periodically delivered to the solar furnace vessel (block 121) to a predetermined fill level and the feed is shut down. The solar furnace will evaporate the contents of the vessel until a predetermined weight or volume or fill level has been evaporated, and then a computer controlled monitoring system will open a bottoms release valve and initiate flushing with salt water (block 125). After the flushing is completed and the vessel is drained of bottoms, the computer will close the bottoms release valve, and may again initiate a fill step and repeat the process as above.

As with the continuous system, the desalination evaporant (steam) travels up a riser pipe for steam generation and hydro generation of electric power (block 123). The desalinated water may be fed to a hydroelectric generator or completely or partially stored. The stored water could be used to create power for the solar furnace when there is no or low sunlight (block 127). The desalination water products may be subject to further water treatment, such as filtering, UV, etc. (block 129). The brine may be treated and brine treatment may include ponding recycling, sea salt production, etc. and combinations (block 111).

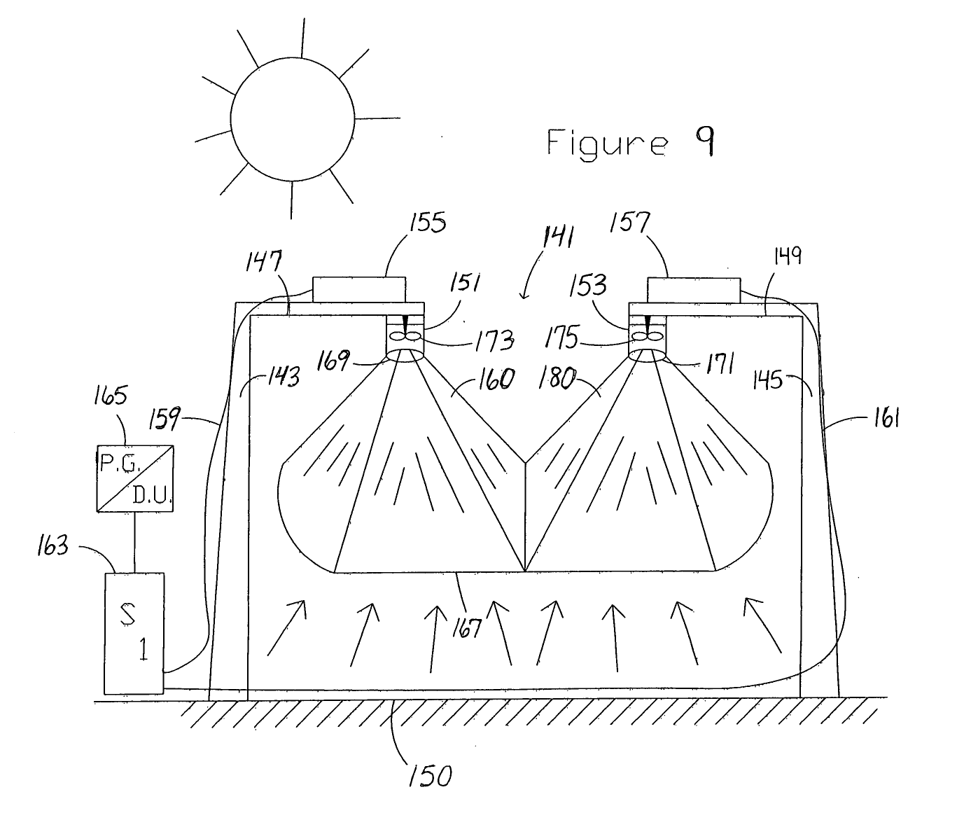

Turning now to FIGS. 9 through 18, a solar-initiated wind power generation system is shown. This power generation system is used to power the at least one pump that feeds seawater or other saltwater into the solar evaporator.

The solar-initiated wind power generation system relies upon the sun to create upwardly flowing air (wind) that is used to generate electricity. The system captures and vortexes solar-initiated upwardly flowing wind into a turbine and power generator. This creates direct electric current (DC) that may be used as such, but is typically converted into alternating current (AC) with an appropriate inverter. Controllers and other conventional and/or ancillary solar and wind power components may be included, such as battery storage and/or back up diesel generators. An essential aspect of the invention is the use of a canopy or a plurality of canopies through which the sunlight passes to heat surfaces below the canopy(ies) and to then carry the upwardly flowing heated air to the canopy apex(es) and to the turbine(s) to generate the power. “Vortexing” and “vortex” as used herein refers to an increase in speed of the airflow based on decreased cross-sectional area of flow. Such movement may or may not include swirling effects. The increase in speed of a moving fluid by restricting its cross-sectional area is also referred to as a venturi effect.

The solar-initiated wind power generation system may be created strictly as a functional structure or it may incorporate aesthetic and/or plural uses into particular designs. For example, functionally, they may also act as a rain umbrella, falling leaf, and other natural falling material shelter, or even as a storage area. The designs may utilize plural apexes, different sizes and different shapes. They could have any footprint desired—round, square, rectangle, oval polygon, combinations, irregular, or other shape. They could have varying heights, alternating heights, etc. The actual spread and height is only limited by the structural limitations of the various components.

Further, the present invention solar canopies can be placed on macadam, concrete, gravel, stone, sand, dirt, grass, patio block, wood or otherwise and may be placed in yards, around pools, on patios, in parking lots, or can be connected to other structures, such as buildings and malls, etc.

FIG. 9 is a front view of an embodiment of a present invention solar-initiated wind power generation system 141, having two canopies 160 and 180 with apexes 169 and 171, respectively, each with its own turbine and generator. Apex 169 of the canopy 160 is connected to turbine housing that contains turbine 173, which is functionally connected to generator 155. Likewise, Apex 171 of canopy 180 is connected to turbine housing 153 that contains turbine 175, which is functionally connected to generator 157. Two canopy support members 143 and 145 are vertical posts with horizontal extensions 147 and 149, respectively. As shown, these support components described above so that canopies 160 and 180 are positioned above (not contacting) ground 150. Sunlight passes through the two connected canopies 160 and 180, heating ground 150, resulting in hot air rising. The hot air slowly rises at the base, but because the canopy cross-sections decrease with height, the speed of the hot air (rising solar wind) increases with increasing height.

Ground level solar thermals coming off concrete parking lots, roofs, macadam, stone or concrete roads, etc. have vertical rise rates of low speeds 3 to 5 mph to higher rates, e.g. 15 mph, depending upon ambient conditions (ΔT, base temperature, winds, shears, temperature layers, fronts, etc.). Thus, ground level thermal updrafts under normal sunny conditions may be between 3 and 8 mph. However, in the present invention systems, the speed is accelerated due to the vortexing and the mathematical relationship between the base wind speed and the apex wind speed, which is the ratio of the base area (area at the bottom of the canopy) to the apex area:

Sₐ=S_{b}(A_{b}/Aₐ)

where Sₐ is the apex wind speed, S_{b} is the base or bottom wind speed, Aₐ is the apex horizontal cross-sectional area and A_{b} is the bottom horizontal cross-sectional area.

For canopies that are circular, the areas are equal to n times the radius squared. Thus, for circular canopies, the updraft speed at the apex is

Sₐ=S_{b}((r_{b})²/(rₐ)²)

where rₐ and r_{b} are the apex and base radius.

Once the apex wind speed is determined or calculated and the diameter of the turbine blades is known, the amount of energy produced can then be determined by theoretical formulas. However, commercially available energy production information is readily available for microturbines and turbines at various average wind speeds. These turbines operated to produce the power whether their axis of rotation is positioned horizontally (as in typical wind turbine installations) or vertically (as in the present invention). Within ranges of variances (efficiencies), the power generated is based on the wind speed and the turbine blade span (sometimes referred to as the turbine diameter).

If a present invention single canopy is set up in a warm region where sun is plentiful and hot, such as Kenya, the Philippines, Barbados, or Ecuador, significant power can be generated with relatively small size present invention solar-initiated wind power generation systems. In temperate environments, larger systems are needed to generate the same power (shorter daylight, smaller ΔTs).

A canopy having a 40 ft diameter (20 ft radius) base and an apex with a 10 ft diameter and a 10 ft turbine blade span, has a ratio of apex speed to base speed of (20)²/(5)²=16. Thus, theoretically, a system with an average base updraft over an eight hour exposure of 4 mph will yield an apex speed of 48 mph. Since it is operating only ⅓ of each 24-hour day on average, the average wind speed at the apex is ⅓ of 48 mph or 16 mph. A 10 ft diameter microturbine can produce 4,000 kWh at approximately 16 mph average daily wind speed, according to published tables and known formulas. Thus, a present invention solar canopy having a 40 to 60 degree angled conical canopy with a base diameter of about 40 feet and an apex outlet of 10 feet with a ten foot diameter turbine, could produce about 4,000 kWh, enough power to satisfy the electric needs of a home in a developing country. Results would be expected to progress greater than linearly (almost geometrically) for increasingly larger systems.

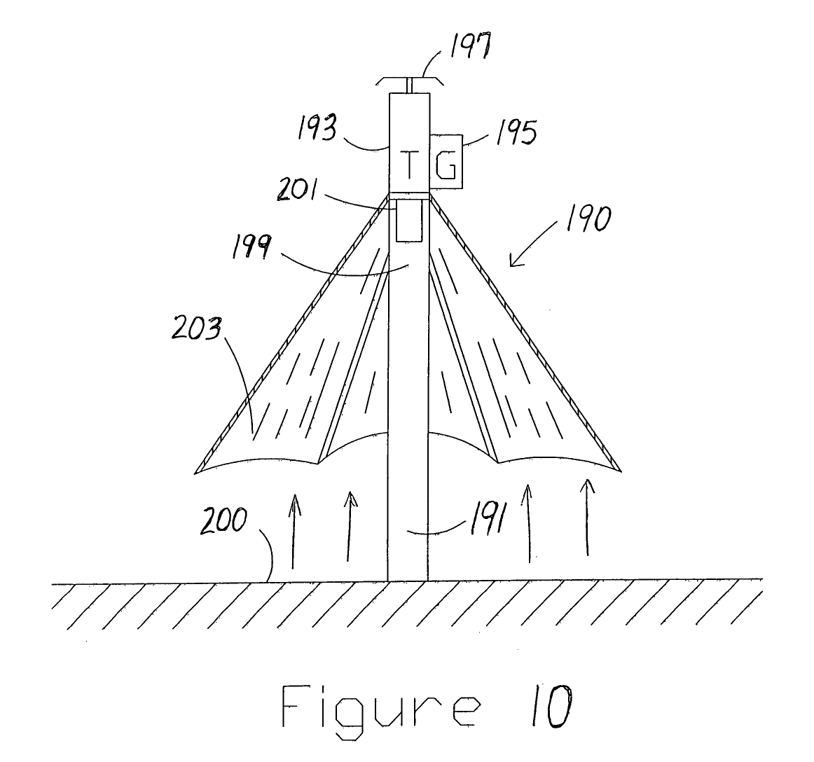

FIG. 10 is a partially cut front view of an embodiment of a present invention solar-initiated wind power generation system 190 having a canopy 203 with a single apex 199 and with the turbine T located inside the hollow top area 193 of the canopy support member 191. The ground surface 200 may be macadam, concrete, wood, metal, rock, dirt, sand, grass, other material or combinations thereof. The sunlight passes through clear canopy 203 (or at the edges of the canopy where sometimes the sunlight passes under the canopy) and heats up ground surface 200. The heated air rises into canopy 203 toward apex 199 and into inlet 201, through turbine T and out vent 197 to turn the turbine T, which translates its rotational forces into generator G in housing 195 to generate electricity. While in this example, the surface is referred to as ground surface 200, this could be a rooftop, an elevated constructed item, such as a deck, patio or porch, or it could be on a platform. The ground surface 200 is shown as flat, but it could be curved, rocky, mountainside or hillside or otherwise. Further, canopy 203 could be rigid clear plastic, flexible plastic sheet, glass, other light transmitting material, or combinations. The canopy may be polygonal, circular, oval or any other shape(s). The arrangements of the present invention such as shown in FIG. 10, with vents, prevent rain entry and thus may function as a protective umbrella, e.g. poolside or parking area.

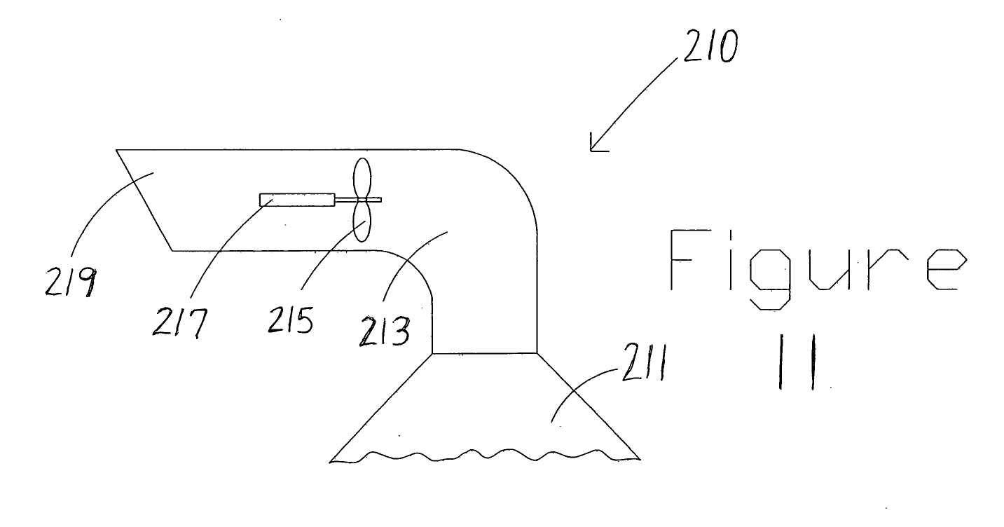

FIG. 11 is a partial cut side view of an embodiment of turbine and generator and solar chimney arrangement of a present invention solar-initiated wind power generation system 210. There is a solar canopy 211 that operates in the same manner as those described above—allow sunlight to pass in and heat up a base, then receive upflowing air (solar wind) and concentrate it toward an apex and feed it to a power-producing turbine with generator. Here, the canopy 211 terminates in a dogleg pipe 213 to direct the air from vertical to horizontal direction to operate turbine 215 and generator 217 to produce power. The solar wind then exits through horizontal exit part 219. This arrangement prevents rain from entering the canopy and thus, enables the canopy to be used as a stationary umbrella when rainy weather occurs.

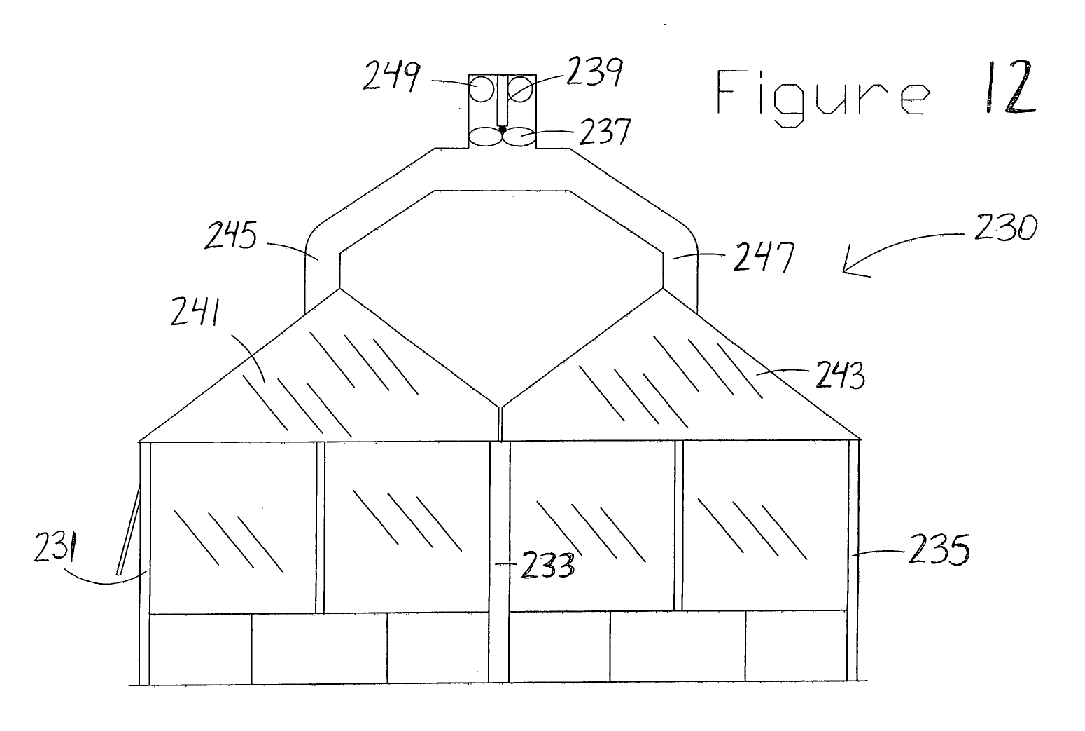

FIG. 12 is a front view of an embodiment of a present invention solar-initiated wind power generation system 230 wherein the canopy is a plurality of greenhouse rigid glass roofs 241 and 243, with two apexes (one apex each), that manifold into a single turbine 237 and generator 239. The greenhouse has glass walls 231, 233 and 235 and glass canopy roofs, that permit the entry of sunlight. As with all greenhouses, there are side windows that may be opened to allow incoming airflow. In this embodiment, the air inside the greenhouse is heated by the sunlight and the resulting rising air is sped up by the venturi effect and moves rapidly into manifold pipes 245 and 247 that meet below turbine 237. The rising hot air turns turbine 237, driving generator 239 to produce electricity. The rising air exits via side vents 249.

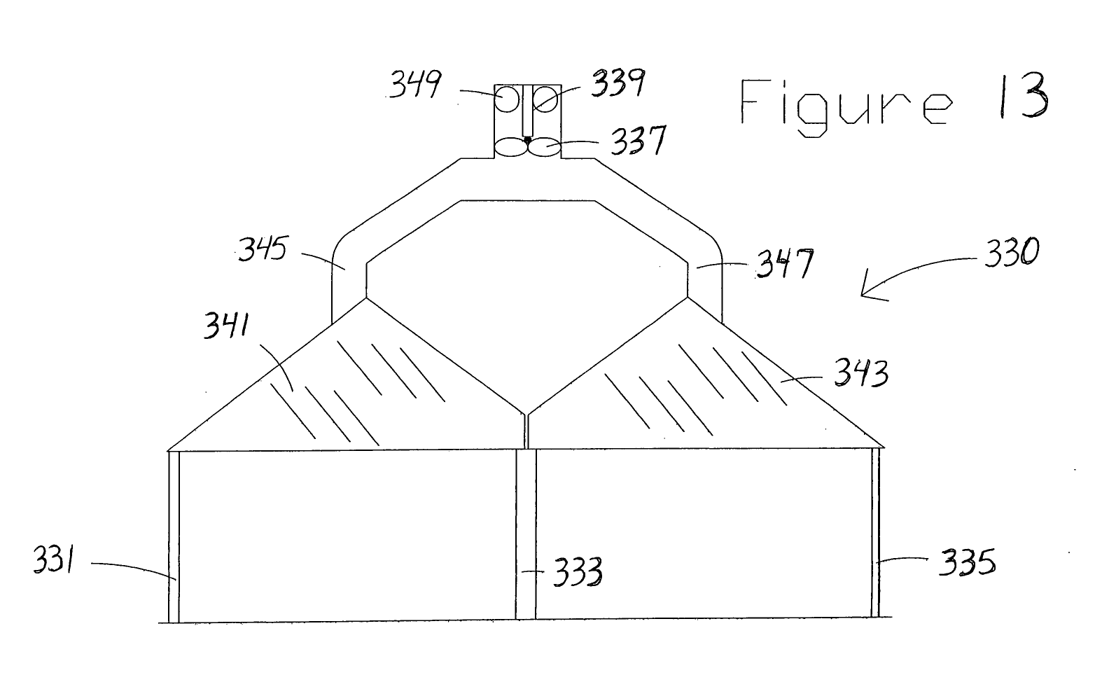

FIG. 13 is a front view of an embodiment of a present invention solar-initiated wind power generation system wherein the canopy is a plurality of tent-like flexible clear plastic roofs with two apexes that manifold into a single turbine and generator. Structurally, it appears to be similar to the greenhouse of FIG. 12, except that the roof is flexible plastic instead of glass or rigid plastic, and there are open walls. Thus, in FIG. 13 there is shown a front view of an embodiment of a present invention solar-initiated wind power generation system 330 wherein the canopy is a plurality of flexible clear plastic roofs 341 and 343 that permit the entry of sunlight, each with its own apex. These apexes manifold into a single turbine 337 and generator 339. The double-apex tent has open walls and support posts 331, 333 and 335. In this embodiment, the air inside the tent is heated by the sunlight and rises. The resulting rising air is sped up by the venturi effect and moves rapidly into manifold pipes 345 and 347 that meet below turbine 337. The rising hot air turns turbine 337, driving generator 339 to produce electricity. The rising air exits via side vents 349.

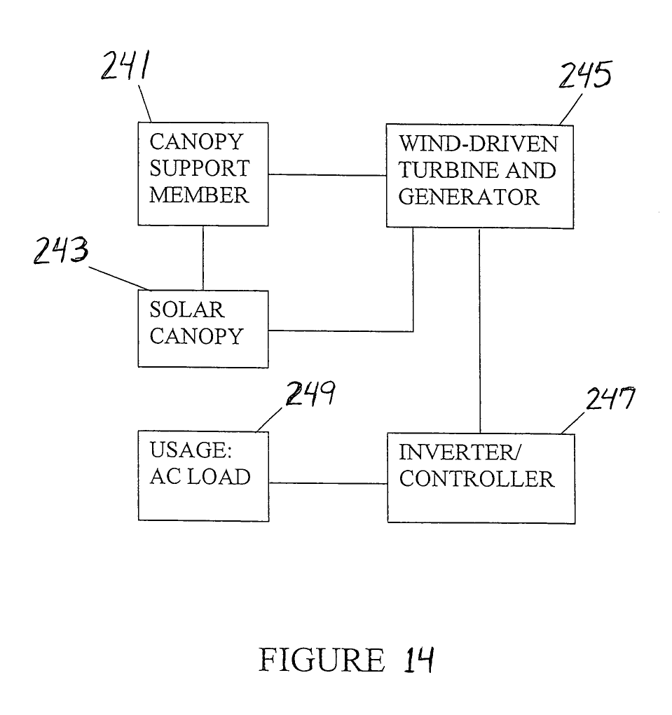

FIGS. 14, 15, 16, 17 and 18 illustrate block diagrammatic representations of various embodiments of the present invention solar-initiated wind power generation system.

In the FIG. 14 block diagram, canopy support member 241 supports the solar canopy 243 and one or both of these, but typically the canopy support member 241, supports the wind turbine and generator 245 that is located at the apex of the canopy. The turbine blades are illustrated in preceding figures as horizontal (vertical axis) or as vertical (horizontal axis) but could be at any effective angle, depending upon the positioning and orientation of the outlet from the apex and the position of the turbine(s). The wind turbine and generator 245 produces direct current that passes through inverter/controller 247 to create alternating current. The alternating current goes to usage 249, which is typically an alternating current load. However, the alternating current could be fed back to the grid, where appropriate, for power credits or payments from the grid power company back to the user.

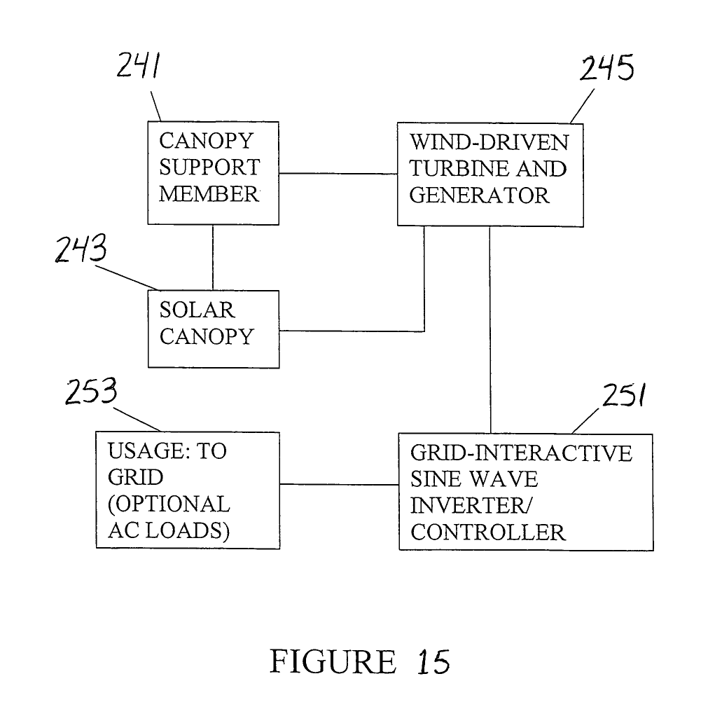

In FIG. 15, the blocks 241, 243 and 245 are the same as shown in FIG. 14 and function in the same manner, except that FIG. 15 shows details for a user connected to a power grid. Thus, inverter/controller 251 must be one that corrects for use on the grid, that is, a grid-interactive sine wave inverter/controller for correct feeding to grid 253.

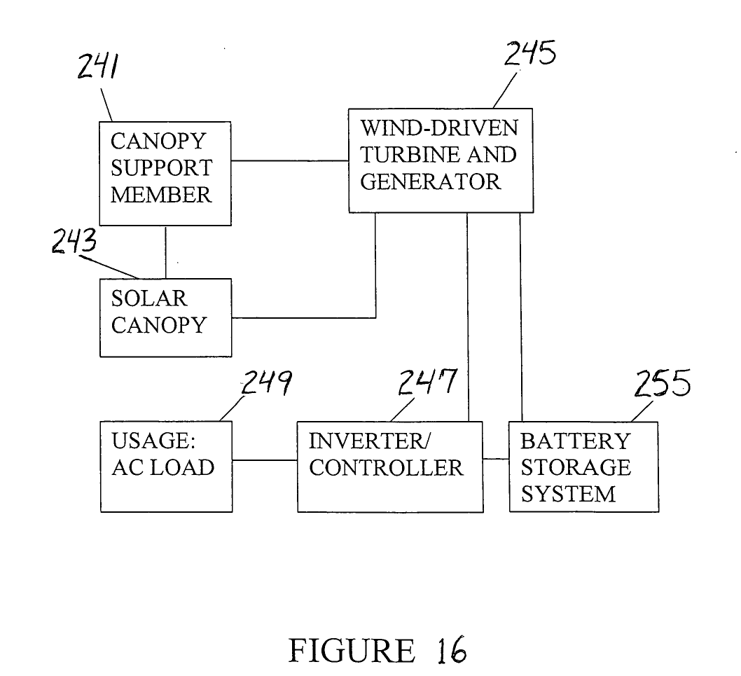

In FIG. 16, the blocks 251, 253, 255, 257 and 259 are the same as shown in FIG. 14 and function in the same manner. In this FIG. 16 embodiment, the direct current from generator 245 may be sent to a battery storage system 255 or directly to inverter/controller 247 for subsequent alternating current load usage 249. Battery storage system 255 can be used for drawing power through inverter/controller 247 for alternating current load usage 259.

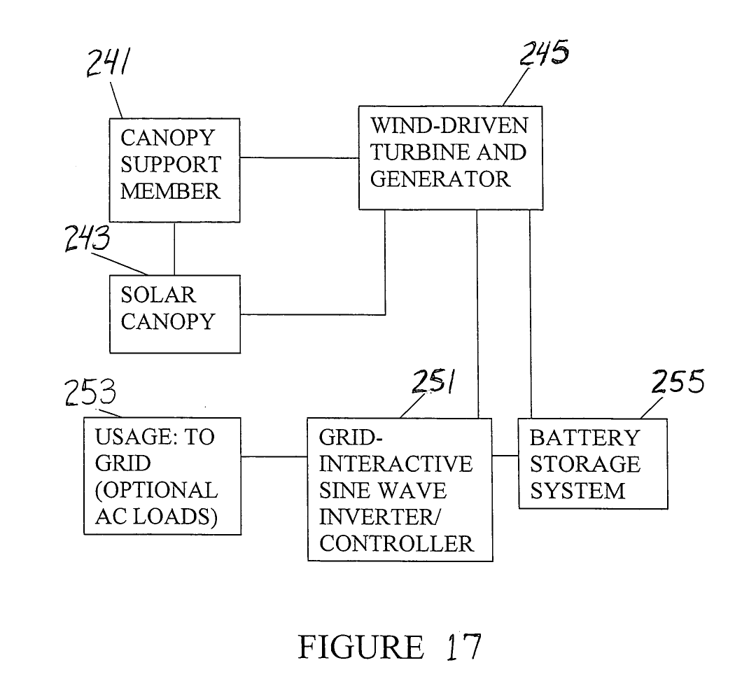

In FIG. 17, the blocks 241, 243 and 245 are the same as shown in FIG. 15 and function in the same manner. In this FIG. 17 embodiment, the direct current from generator 24 may be sent to a battery storage system 255 or directly to grid-interactive sine wave inverter/controller 247 for subsequent alternating current load usage 253. Battery storage system 255 can be used for drawing power through inverter/controller 251 for alternating current load usage 253.

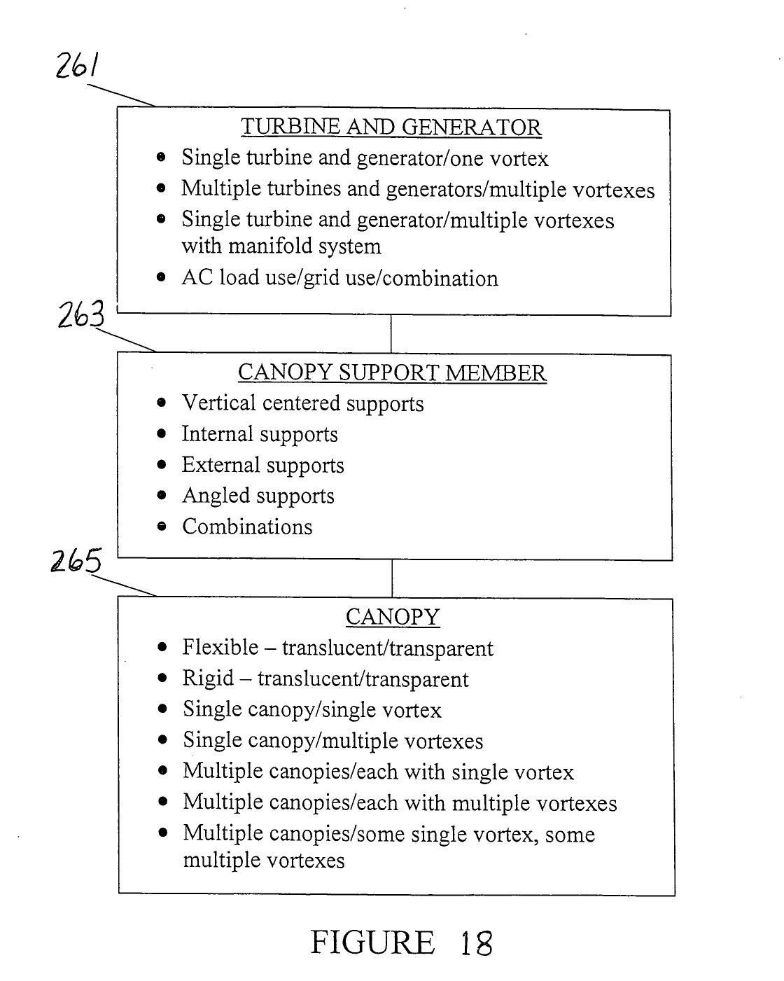

FIG. 18 illustrates a block diagrammatic representation of various embodiment options of the present invention solar-initiated wind power generation system. Block 265 describes some preferred canopy options. These include flexible-translucent or transparent, rigid-translucent or transparent, single canopy/single vortex, single canopy/multiples vortexes, multiple canopies/each with single vortex, multiple canopies, each with multiple vortexes, and multiple canopies/some single vortex, some multiple vortexes. Block 263 illustrates various canopy support member options. These include vertical centered supports, internal supports, external supports, angled supports, and combinations. Block 261 describes turbine and generator options. These include single turbine and generator/one vortex, multiple turbines and generators/multiple vortexes, single turbine and generator/multiple vortexes with manifold system, and AC load use/grid use/combinations.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A solar desalination system for creation of desalinated water from seawater, which comprises:
a) a solar furnace unit including a vessel for receiving and evaporating seawater to create desalinated steam and a solar energy concentrator positioned adjacent said vessel to concentrate solar energy to said vessel;
b) input means for feeding seawater to said vessel;
c) brine output means for removal of brine water bottoms from said vessel;
d) a riser pipe having a top and a bottom and being connected at its bottom and extending upwardly from said vessel for transporting steam from said vessel, said riser pipe top positioned at a predetermined vertical height from said vessel;
e) an electric power-producing steam turbine generator positioned at a predetermined vertical height from said vessel, and connected to said top of said riser pipe for production of electric power with steam from said container;
a drop pipe having a top and a bottom, and being connected at its top to said steam turbine generator for removal of desalinated water from said steam turbine generator;
g) an electric power-producing hydroturbine generator connected to said bottom of said drop pipe for production of electric power with desalinated water from said steam turbine generator; and,
h) egress means for removal of desalinated water from said hydroturbine generator for subsequent use;
wherein said input means for feeding seawater to said vessel includes
i) at least one support member adapted to support, and being connected to and supporting, a solar canopy above ground level;
ii) at least one wind-driven power turbine and generator connected to said at least one support member and to an apex of said solar canopy;
iii) said solar canopy, having a periphery and an inner area wherein said inner area is at least partially elevated above said periphery to establish at least one apex with a venturi effect, said solar canopy being connected to said at least one support member, said solar canopy having a major portion being selected from the group consisting of translucent material, transparent material and combinations thereof, said at least one apex of said solar canopy being functionally connected to said at least one wind-driven power turbine and generator;
iv) at least one inverter connected to said generator to convert direct current electric power from said at least one wind-driven power turbine and generator to alternating current electric power;
v) an electrical storage means connected to one of said at least one inverter and said at least one wind-driven power turbine and generator; and,
vi) an electric pump electrically connected to said at least one wind-driven power turbine and generator, said electric pump adapted to feed seawater into said vessel.

2. The solar desalination system for creation of desalinated water from seawater of claim 1 wherein said solar canopy is a flexible plastic canopy.

3. The solar desalination system for creation of desalinated water from seawater of claim 1 wherein said solar canopy is a rigid canopy selected from the group consisting of glass, glass fiber and plastic.

4. The solar desalination system for creation of desalinated water from seawater of claim 1 wherein said at least one wind-driven power turbine includes blades that rotate about a vertical axis.

5. The solar desalination system for creation of desalinated water from seawater of claim 1 wherein said at least one wind-driven power turbine includes a protective top element to inhibit rain entry.

6. The solar desalination system for creation of desalinated water from seawater of claim 1 wherein said at least one support member is a support column having a hollow top section wherein said hollow top section includes at least one wind entry port and contains said at least one wind-driven power turbine within said hollow top section above said at least one wind entry port, and wherein said solar canopy at least one apex is connected to said support column adjacent and above said at least one wind entry port.

7. The solar desalination system for creation of desalinated water from seawater of claim 1 wherein there is a plurality of apexes and there is one turbine and generator and there is a manifold connected to said plurality of apexes and connected to said one turbine and generator.

8. The solar desalination system for creation of desalinated water from seawater of claim 1 wherein there is a plurality of apexes and there is one turbine and generator for, and connected to, each of said plurality of apexes.

9. The solar desalination system for creation of desalinated water from seawater of claim 1 wherein said at least one wind-driven power turbine and generator includes blades that rotate about anon-vertical axis.

10. The solar desalination system for creation of desalinated water from seawater of claim 1 wherein said system further includes a heat reflecting material located a predetermined distance below the periphery of said solar canopy.

11. The solar desalination system for creation of desalinated water from seawater of claim 1 wherein said solar canopy has a lower portion and an upper portion and said lower portion has a greater horizontally-measured area than said upper portion.

12. The solar desalination system for creation of desalinated water from seawater of claim 11 wherein said solar canopy has a single apex and has a decreasing horizontally-measured area as a function of increasing height.

13. A solar desalination system for creation of desalinated water from seawater, which comprises:
a) a solar furnace unit including a vessel for receiving and evaporating seawater to create desalinated steam and a solar energy concentrator positioned adjacent said vessel to concentrate solar energy to said vessel;
b) input means for feeding seawater to said vessel;
c) brine output means for removal of brine water bottoms from said vessel;
d) a riser pipe having a top and a bottom and being connected at its bottom and to extending upwardly from said vessel for transporting steam from said vessel said riser pipe top positioned at a predetermined vertical height from said vessel;
e) an electric power-producing steam turbine generator positioned at a predetermined vertical height from said vessel, and connected to said top of said riser pipe for production of electric power with steam from said container;
f) a drop pipe having a top and a bottom, and being connected at its tops to said steam turbine generator for removal of desalinated water from said steam turbine generator;
g) an electric power-producing hydroturbine generator connected to said bottom of said drop pipe for production of electric power with desalinated water from said steam turbine generator; and,
h) egress means for removal of desalinated water from said hydroturbine generator for subsequent use;
wherein said input means for feeding seawater to said vessel includes
vii) at least one support member adapted to support, and being connected to and supporting, a solar canopy above ground level;
viii) at least one wind-driven power turbine and generator connected to said at least one support member and to an apex of said solar canopy;
ix) said solar canopy, having a periphery and an inner area wherein said inner area is at least partially elevated above said periphery to establish at least one apex with a venturi effect, said solar canopy being connected to said at least one support member, said solar canopy having a major portion being selected from the group consisting of translucent material, transparent material and combinations thereof, said at least one apex of said solar canopy being functionally connected to said at least one wind-driven power turbine and generator;
x) at least one inverter connected to said at least one wind-driven power turbine and generator to convert direct current electric power from said at least one wind-driven power turbine and generator to alternating current electric power;
xi) an electrical storage means connected to one of said at least one inverter and said at least one wind-driven power turbine and generator; and,
xii) an electric pump electrically connected to one of said electrical storage means and said at least one wind-driven turbine and generator, said electric pump adapted to feed seawater into said vessel.

14. The solar desalination system for creation of desalinated water from seawater of claim 13 wherein said riser pipe top and said steam turbine generator are at least 30 meters higher than said vessel.

15. The solar desalination system for creation of desalinated water from seawater of claim 13 wherein said solar energy concentrator is selected from the group consisting of a linear parabolic solar concentrator, a parabloid solar concentrator and plural mirror solar concentrator.

16. The solar desalination system for creation of desalinated water from seawater of claim 15 wherein said solar energy concentrator is moveably mounted, and includes solar tracking means adapted to move said solar energy concentrator to follow the sun.

17. The solar desalination system for creation of desalinated water from seawater of claim 13 wherein said system further includes:
i.) auxiliary heating means proximate said vessel and adapted to heat said vessel to assist said solar furnace.

18. The solar desalination system for creation of desalinated water from seawater of claim 17 wherein said auxiliary heating means is adapted to operate when solar power is insufficient to evaporate seawater in said vessel.

19. The solar desalination system for creation of desalinated water from seawater of claim 17 wherein said auxiliary heating means is an electric heating means that is powered from at least one of said generators.

20. The solar desalination system for creation of desalinated water from seawater of claim 13 wherein said riser pipe includes at least one booster heater.

21. The solar desalination system for creation of desalinated water from seawater of claim 20 wherein said at least one booster heater is selected from the group consisting of a solar heater, a heat exchange heater, an electric heater and combinations thereof.

22. The solar desalination system for creation of desalinated water from seawater of claim 13 wherein said egress means includes heat exchange cooling means.

23. The solar desalination system for creation of desalinated water from seawater of claim 13 wherein said system includes an elevated storage tank connected to and downstream from said steam turbine generator and connected to said drop pipe, adapted for storage and controlled release of desalinated water to provide water and power when said solar furnace unit is not producing water and electricity.
